(19) United States
(12) Patent Application Publication
(10) Pub. No.: US 2021/0304518 A1
(43) Pub. Date: Sep. 30, 2021

(54) METHOD AND SYSTEM FOR GENERATING AN ENVIRONMENT MODEL FOR POSITIONING

(71) Applicants: Continental Automotive GmbH, Hannover (DE); Continental Holding China Co., Ltd., Yangpu Shanghai (CN)

(72) Inventors: Bingtao Gao, Chengdu City (CN); Christian Thiel, Oberaudorf (DE); Paul Barnard, Somerset (GB)

(21) Appl. No.: 17/344,387

(22) Filed: Jun. 10, 2021

Related U.S. Application Data
(63) Continuation of application No. PCT/CN2018/120904, filed on Dec. 13, 2018.

(51) Int. Cl. G06T 19/20; G06T 15/08; G06T 15/00; G06T 15/20

(52) U.S. Cl. CPC G06T 19/20; G06T 15/08; G06T 2219/2024; G06T 15/205; G06T 2219/2004; G06T 15/005

(57) ABSTRACT

Method and system for generating an environment model for positioning include the generation of a 3D model of a scanned environment from a mobile entity, the 3D model being construed as a point cloud. A segmentation of the point cloud of the 3D model in a plurality of segmented portions of the point cloud is performed, and 3D objects are modelled directly from the point cloud by analyzing each of the segmented portions of the point cloud. The generated 3D model of the scanned environment is matched with an existing 3D model of the environment. A database representing of an improved 3D model of the environment is generated by aligning the existing 3D model of the environment and the generated 3D model of the scanned environment.

### CROSS-REFERENCE TO RELATED APPLICATIONS

This application is a continuation of pending International Application No. PCT/CN2018/120904 filed on 13 Dec. 2018, which designates the United States. The disclosure of PCT/CN2018/120904 is incorporated by reference herein.

### BACKGROUND

### 1. Field of the Invention

The invention relates to a method for generating an environment model for positioning, to a mobile entity for generating an environment model for positioning the mobile entity and to a system for generating an environment model for positioning a mobile entity.

### 2. Description of Relevant Art

Advanced driver systems and autonomously driving cars require high precision maps of roads and other areas on which vehicles can drive. Determining a vehicle's position on a road with high accuracy, which is needed for self-driving cars cannot be achieved by conventional navigation systems, such as satellite navigation systems, for example GPS, Galileo, GLONASS, or other known positioning techniques, e.g. triangulation. However, in particular when a self-driving vehicle moves on a road with multiple lanes, it is desired to exactly determine the position of the vehicle on one of the lanes.

Regarding high precision navigation, it is necessary to have access to a digital map in which objects being relevant for the secure driving of an autonomously driving vehicle are captured. Test and simulations with self-driving vehicles have shown that a very detailed knowledge of the vehicle's environment and specification of the road is required.

However, conventional digital maps of the environment of a road, which are used today in conjunction with GNSS tracking of vehicle movements may be sufficient for supporting the navigation of driver-controlled vehicles, but they are not detailed enough for self-driving vehicles. Scanning the roads with specialized scanning vehicles provides much more details, but is extremely complex, time-consuming and expensive.

### SUMMARY OF THE INVENTION

The embodiments are providing a method for generating an environment model for positioning, which enables a creation of a precise model of the environment, of a self-driving mobile entity, that contains road information and other information of driving-relevant objects located in the environment of the self-driving mobile entity with high precision. Further, a mobile entity is provided for generating an environment model for positioning a mobile entity and a system for generating an environment model for positioning a mobile entity.

In an embodiment, a method for generating an environment model for positioning includes a step of generating a 3D model of a scanned environment from a mobile entity, for example a self-driving car. The generated 3D model may be construed (configured) as a point cloud being a representation of the scanned environment of the mobile entity. At the next step, a segmentation of the point cloud of the 3D model into a plurality of segmented portions of the point cloud is performed. AT a subsequent step, 3D objects are modelled directly from the point cloud by analyzing each of the segmented portions of the point cloud.

In a subsequent step, a 3D model matching may be performed. The generated 3D model of the scanned environment may be matched with an existing (or, reference) 3D model of the environment. In a next step of the method, a database (which may be configured to be a representation of an improved 3D model of the environment) may be generated by spatially aligning the existing 3D model of the environment and the generated 3D model of the scanned environment.

The method may further include a step of generating a trajectory showing the path the mobile entity, for example an autonomously controlled vehicle, may be driving. The generation of the trajectory may be executed on the side of the mobile entity by evaluating images captured by a camera system of the mobile entity or by evaluating data obtained from other sensors of the vehicle. For this purpose, a plurality of techniques, for example a VO (Vison Odometry) technique or a SLAM (Simultaneous Localization and Mapping) technique can be used.

The point cloud to depict the scanned environment as a 3D model can be generated as a dense or a semi-dense point cloud. The point cloud generation which provides a representation of the scanned environment as a 3D model of the environment of the mobile entity can be based on input data obtained during the step of generating of the trajectory. According to a related embodiment, the point cloud can directly be created from raw images of a camera system installed in the mobile entity or from other sensor data.

During the step of point cloud segmentation, the generated point cloud is segmented into small pieces, i.e. into segmented portions, which are associated to an object detected in the environment of the mobile entity based on the physical distribution of the object in space.

A respective 3D model of detected objects is created during the step of point cloud 3D modelling for each of the portions segmented from the point cloud. A detected 3D object may be modelled with respect to shape, size, orientation, location in space, etc. Other attributes—such as type of object, color, texture etc.—can also be added to the object extracted from the point cloud of the 3D model of the scanned environment. For this purpose, some traditional 2D object recognition algorithms may be used. All the attributes added to a detected object can provide additional information to identify each of the 3D objects.

During the step of 3D model matching, the generated 3D model of the scanned environment can be used to be compared or fitted with an existing (reference) 3D model of the environment. The matching process can be performed on the mobile entity/vehicle side or on a remote server side. The already existing 3D model of the environment may be construed or configured as a point cloud and can be stored in a storage unit of the mobile entity of a remote server.

For a certain environment, for example a section of a road, multiple 3D models of the environment generated by a plurality of mobile entities may be matched. However, some of these models may be wrongly matched (or matched with errors). An outlier removal method such as the RANSAC (Random Sample Consensus) technique/algorithm can be used to improve the robustness of the 3D model matching procedure.

As a result, each matched pair of a newly generated 3D model of the scanned environment and the existing 3D model of the environment provides additional information. The physical location of matched 3D models of the environment or of objects in the environment should in theory be exactly the same, adding some constraints to the system. With those new constraints, the system error between two databases of 3D models can be greatly reduced. This can also help to align two unsynchronized databases of 3D models of an environment/scenario and merge them together.

The method allows that a plurality of 3D models of a scanned environment may be compared and aligned and then can be merged together. By merging and aligning (for example, scaling along and/or shifting with respect to at least one of the three Cartesian axes) the various models together (to have these models substantially match), a global 3D model/map of a scenario can be generated.

The number of landmarks/3D models generated in this way can be much higher than those generated with the use of some traditional object detection and recognition algorithms, because the proposed methodology for generating an environment model does not require to necessarily recognize the objects (as the methods of the related are do). The evaluation of the dense/semi-dense point clouds of the 3D model of an environment allows to easily and directly extract some geometric information of an object, such as the position, the size, the height, the shape, the orientation, etc. of the object.

Furthermore, point cloud-based object matching used by the presented method for generating an environment model is not sensitive to the viewing angle, so it can be used to align objects with a large viewing angle difference (even direction reversal). The proposed method can work independently or as a good complement to some other methods such as feature point based alignment.

The proposed method for generating an environment model for positioning can be used in the field of autonomous vehicle navigation, autonomous vehicle localization as well as for crowdsourcing database generation and for aligning, merging and optimizing a crowd-sourced database. In order to position a mobile entity, on the mobile entity/vehicle side, landmarks may be searched in the environment using a dense or semi-dense point cloud of a 3D model of the environment. The found landmarks are matched with landmarks stored in a database which is a representation of a previously generated 3D model of the environment. Alignment data may be collected from multiple mobile entities/vehicles driving on opposite sides of a road. The alignment of data from multiple mobile entities/vehicles driving in other difficult scenarios may be improved.

An embodiment relates to a mobile entity for generating an environment model for positioning the mobile entity, for example a self-driving vehicle.

According to an embodiment, the mobile entity for generating an environment model for positioning the mobile entity includes an environmental sensor unit to scan an environment of the mobile entity, and a storage unit to store a generated 3D model of the scanned environment of the mobile entity. The mobile entity further includes a processor unit to execute instructions which, when executed by the processor unit, in cooperation with the storage unit, perform processing steps of the method for generating an environment model for positioning the mobile entity as described above.

An embodiment relates to a system for generating an environment model for positioning a mobile entity.

According to an embodiment, the system includes the mobile entity for generating a 3D model of a scanned environment of the mobile entity, wherein the 3D model may be construed as a point cloud. The system further includes a remote server including a processor unit and a storage unit to store an existing 3D model of the environment of the mobile entity. The processor unit may be embodied to execute instructions, which, when executed by the processor unit of the remote server in cooperation with the storage unit, perform processing steps of the method for generating an environment model for positioning the mobile entity as described above. The processing steps include at least the matching of the generated 3D model with the existing 3D model of the environment and the generation of the database of the improved 3D model of the environment

Additional features and advantages are set forth in the detailed description that follows. It may be to be understood that both the foregoing general description and the following detailed description are merely exemplary, and are intended to provide an overview or framework for understanding the nature and character of the claims.

### BRIEF DESCRIPTION OF THE DRAWINGS

In the following, the invention will be described by way of example, without limitation of the general inventive concept, on examples of embodiment and with reference to the drawings, of which:

FIG. 1 illustrates an example of a simplified flowchart representing an embodiment of a method for generating an environment model for positioning; and

FIG. 2 shows an example of a simplified block diagram of a system configured for generating an environment model for positioning a mobile entity.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention may be to cover all modifications, equivalents and alternatives falling within the spirit and scope of the present invention as defined by the appended claims.

### DETAILED DESCRIPTION

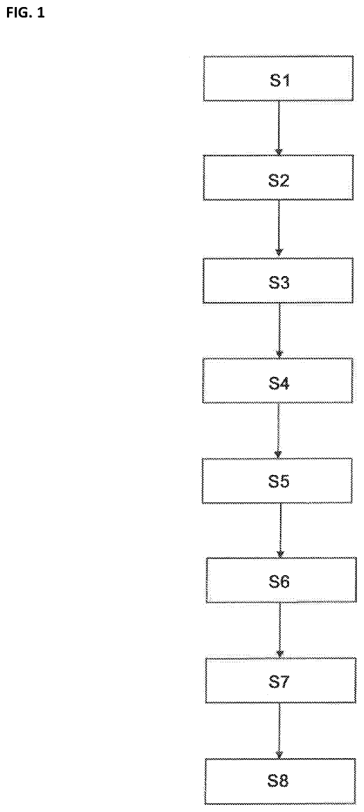

A method for generating an environment model for positioning which may be used, for example, to generate an environment model of an autonomously driving mobile entity/vehicle which model may be used for positioning the mobile entity/vehicle may be explained in the following with reference to FIG. 1 illustrating different steps of the method.

Consider a vehicle driving along a path and collecting data containing information regarding the environment of the vehicle along the driven path. The collected data may be aligned with information/data about the environment of the vehicle that is/are already present in or at the vehicle. (Such information/data may be provided, for example, as a database stored in an internal storage unit of the vehicle.) By aligning and matching the data captured while driving along the path with the previously stored data, a new composite data set can be created. In particular, a 3D model of an environment currently scanned by a sensor system of a driving vehicle may be matched and aligned with previously created 3D models of the same environment to produce a new database representing the environment and, in particular, driving-relevant objects in the environment of a driving route of a vehicle.

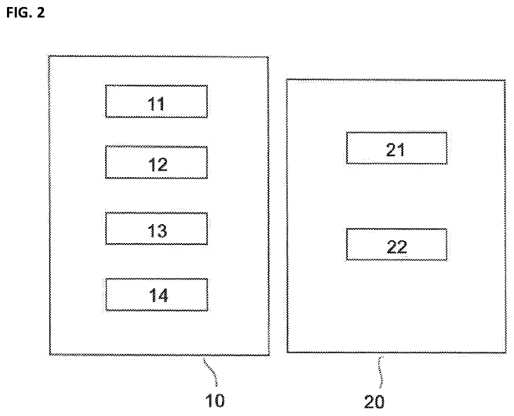

FIG. 2 shows a mobile entity 10 and a remote server 20 with their respective components which may be used to execute the method for generating the environment model for positioning the mobile entity. The different components of the system are described in the following description of the steps of the method.

Step S1 identified in FIG. 1 may be optional and relates to the generation of a trajectory of a mobile entity, for example a self-driving vehicle, during a movement of the mobile entity. During step S1 of trajectory generation the path/trajectory of a moving mobile entity/vehicle in a scenario is determined. For this purpose, an environmental sensor 11 of the mobile entity/vehicle 10 collects information about the environment of the path along which the mobile entity/vehicle drives. In order to obtain the trajectory, data captured by the environmental sensor of the mobile entity can be evaluated by VO (Vision Odometry) techniques or SLAM (Simultaneous Localization and Mapping) techniques.

The environmental sensor 11 may include a camera system (e.g. a CCD-based optical imaging camera) suitable for acquiring or capturing images in the visible and/or infrared (IR) portions of the spectrum. The camera system may include a simple mono-camera or, alternatively, a stereo camera, which may have multiple (for example, two) imaging sensors mounted distant from each other. Additional sensors for example at least one radar sensor and/or at least one laser sensor or at least one RF channel sensor and/or at least one infrared sensor—may be used for scanning and detecting the environment of the mobile entity 10 and for generating the trajectory along which the mobile entity 10 may be moving.

According to an embodiment, step S1 of trajectory generation may include a determination of a traffic lane that may be used by the mobile entity. Furthermore, the generation of the trajectory may include generating a profile of at least one of a velocity and an acceleration of the mobile entity. The velocity/acceleration of the mobile entity 10 may be determined in step S1 in a three-dimensional space (that is, along at least one of the three spatial directions). Further significant parameters defining specific properties of the road (for example any of the width, the direction, the curvature, the number of lanes in each direction, the width of the lanes or the surface structure of the road) may be determined in step S1.

The environment scanned by the mobile entity/vehicle 10 driving along the path/trajectory may be the modelled in step S2 by means of a 3D model configured as a 3D point cloud. Such 3D model may be generated from the entire scanned environment of the mobile entity during driving along the trajectory. Driving-relevant objects in the environment are described in the generated 3D model as portions of the point cloud. The 3D point cloud may be generated with different degrees of density. Thus, a dense or semi-dense point cloud may be generated in step S2 as a representation of the scanned environment. The point cloud of the 3D model of the scanned environment may be stored in a storage unit 12 of the mobile entity 10. Here, a person of skill in the art will appreciate that degrees of density of the point cloud may be defined, for example, in accord with the common understanding of such degrees in related art. For example, a point cloud is considered to be sparse when its density is from about 0.5 pts/m² to about 1 pts/m²; the density of the low-density point cloud is substantially between 1 pts/m² and 2 pts/m²; the medium density point cloud may be characterized by the density of about 2 pts/m² to 5 pts/m²; and the high density point cloud has a density from about 5 pts/m² to about 10 pts/m². The point cloud is considered to be extremely dense if its density exceeds 10 pts/m².

In step S3 the 3D model/point cloud generated in step S2 may be evaluated. During evaluating the generated point cloud included in the 3D model, the point cloud may be segmented into small pieces/portions based on their physical distribution in space. The evaluation algorithm can determine which points in the point cloud belong to a certain object, for example a tree, traffic lights, other vehicles in the scenario, etc. According to an embodiment, the evaluation of the complete point cloud of the 3D model of the environment may be performed by an algorithm using a neural network, for example an artificial intelligence algorithm.

In step S4, 3D objects recognized in the point cloud of the generated 3D model of the scanned environment may be modelled/extracted by analyzing each of the segmented portions of the point cloud. The modelling/extracting of objects in the 3D model of the scanned environment may be directly done from the generated 3D point cloud. As a result, information with respect to shape, size, orientation and/or location of an object in the captured scene is created for each segmented portion of the point cloud of the 3D model of the scanned environment.

In step S5, in addition to the shape, size, orientation and/or localization of an extracted object of the 3D model of the scanned environment, other attributes (such as, for example, a type of object, color, texture etc.)—that is quality or features regarded as a characteristic or inherent part of an item under consideration—can be added to each of the extracted objects in the generated 3D model. Respective attributes characterizing the 3D objects in the generated 3D model of the scanned environment are associated to each of the extracted/modelled objects.

In the step S6, the generated 3D model of the scanned environment may be matched with an existing 3D model of the environment.

In one example, a database/data set of the existing 3D model of the environment of the mobile entity may be stored in the storage unit 12 of the mobile entity 10. In the case when the 3D model matching of step S6 is executed by the mobile entity 10, the matching may be performed by a processor unit 13 of the mobile entity 10. According to another embodiment, a database/data set that represents the generated 3D model of the scanned environment (and that may be stored in the storage unit 12 of the mobile entity 10) is forwarded from the mobile entity 10 to a remote server 20 to perform the matching of the 3D model of the scanned environment generated in the mobile entity 10 with the (pre-)existing (reference) 3D model of the environment (that may be stored in the storage unit 22 of the remote server 20). The database/data set describing or representing the 3D model (the model that is generated in the mobile entity 10 and that may be a representation of the scanned environment of the mobile entity) may be forwarded from the mobile entity to the remote server 20 via a communication system 14 of the mobile entity 10. The model matching may then be executed by a processor unit 21 of the remote server 20.

In the method step S7, outliers that may result at the step of the 3D model matching may be removed. According to an embodiment of the method, a complete generated 3D model of the scanned environment may be removed from further processing (after matching the generated 3D model with an existing model) depending on the detected conformity between the generated 3D model and the already existing 3D model (that is, based on a degree of mismatching or difference between these two models in light of a pre-determined threshold of mismatching).

In a related embodiment, at least one of the modelled/extracted objects of the generated 3D model of the scanned environment may be removed from further processing (after matching the generated 3D model with the already existing 3D model) depending on the detected conformity between the generated 3D model and the existing 3D model.

In particular, when the generated 3D model contains a large number of differences or deviations from an existing 3D model of the environment of the mobile entity, the newest generated 3D model or a modelled/extracted object in the newest generated 3D model of the environment may be rejected or excluded from further processing.

In the method step S8, a database (which may be a representation of an improved 3D model of the environment of the mobile entity) may be generated by aligning (spatially, for example) the existing 3D model of the environment and the generated 3D model of the scanned environment. For this purpose, the currently generated 3D model of the scanned environment may be compared with the previously generated and now already existing 3D model of the environment. The existing 3D model may be generated by evaluating 3D models of the environment captured from other mobile entities/vehicles which previously drove along the same trajectory as the mobile entity/vehicle 10.

In the method step S8, the currently generated 3D model and the already existing (reference) 3D model of the same environment are composed or at least partially combined to generate the improved database being the representation of the improved 3D model of the environment of the mobile entity. The composition of the various 3D models of the same environment may be performed in the mobile entity 10 or in the remote server 20.

If the improved 3D model of the environment may be composited in the remote server 20, the database/data set describing the 3D model may be transmitted from the remote server 20 to the mobile entity 10. The combination of the 3D model of the scanned environment currently generated in the mobile entity 10 and the already existing 3D model of the environment results in data sets having a high accuracy and precise positioning information of objects.

The mobile entity 10 may compare the 3D model of the environment received from the remote server 20 with a 3D model generated by the mobile entity by scanning the environment. In one case, the mobile entity 10 determines its position by matching and aligning the 3D model of the environment received from the remote server 20 and the generated 3D model of the scanned environment. According to another embodiment, the position of the mobile entity 10 may be determined by the remote server by matching and aligning the 3D model of the environment generated by the mobile entity 10 and the 3D model of the environment being available on the server side.

It will be appreciated by those skilled in the art having the benefit of this disclosure that this invention may be believed to provide method and system configured to generate an environment model. An embodiment of the system includes a mobile entity configured to devise a generated 3D model of a scanned environment, and a remote server comprising a processor operably coupled with a storage unit configured to store an existing 3D model of the environment. It is understood that either of the processors discussed above is preferably equipped with program code which, when loaded on the processor, causes the processor to carry out at least the steps of generating a 3D model of the scanned environment, forming a plurality of segmented portion of the point cloud of the generated 3D model by segmenting the point cloud, extracting description of 3D objects directly from the segmented portions of the point cloud, matching the generated 3D mode of the scanned environment with a reference 3D model of the environment to define a degree of conformity between these two, and generating a database representing an improved 3D model of the environment by aligning the existing 3D model with the generated 3D model. Further modifications and alternative embodiments of various aspects of the invention will be apparent to those skilled in the art in view of this description. Accordingly, this description may be to be construed as illustrative only and may be provided for the purpose of teaching those skilled in the art the general manner of carrying out the invention. It may be to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for generating an environment model for positioning, the method comprising:
generating a 3D model of a scanned environment from a mobile entity to form a generated 3D model of the scanned environment, the generated 3D model configured as a point cloud,
forming a plurality of segmented portions of the point cloud of the generated 3D model by segmenting the point cloud;
extracting descriptions of 3D objects directly from the segmented portions of the point cloud,
matching the generated 3D model of the scanned environment with an existing 3D model of the environment to define a degree of conformity therebetween,
generating a database representing an improved 3D model of the environment by aligning the existing 3D model of the environment and the generated 3D model of the scanned environment.

2. The method of claim 1, further comprising:
generating a trajectory of the mobile entity during a movement of the mobile entity before said generating the 3D model of the scanned environment.

3. The method of claim 2,
wherein the generating a trajectory includes evaluating images captures by a camera system of the mobile entity.

4. The method of claim 2, further comprising:
determining a profile of at least one of a velocity of the mobile entity and an acceleration of the mobile entity in three spatial directions.

5. The method of claim 1, further comprising:
removing the generated 3D model or an extracted description of at least one of the 3D objects of the generated 3D model after said matching the generated 3D model with the existing model depending on the detected conformity between the generated 3D model and the existing model.

6. The method of claim 1, wherein a dense or semi-dense point cloud may be generated as a representation of the scanned environment.

7. The method of claim 1, wherein said extracting includes defining descriptions of the 3D objects with respect to shapes, sizes, orientations, and locations of said 3D objects in the scanned environment.

8. The method of claim 1, wherein said extracting comprises including respective attributes characterizing said 3D objects in said descriptions.

9. The method of claim 1, further comprising:
forwarding a database representing the generated 3D model of the scanned environment from the mobile entity to a remote server to perform said matching.

10. The method of claim 1, comprising:
extracting additional information to be added to the database of the improved 3D model of the environment by comparing the existing 3D model of the environment and the generated 3D model of the scanned environment.

11. A mobile entity configured to generate an environment model for positioning the mobile entity therein, the mobile entity comprising:
an environmental sensor unit configured to scan an environment of the mobile entity,
a storage unit configured to store a 3D model of the environment of the mobile entity generated by scanning thereof with said environmental sensor unit,
a processor in operable cooperation with the storage unit and having access to the generated 3D model, the processor configured to execute instructions which, when executed by the processor, cause the processor to perform at least one of steps of the method according to claim 1.

12. A system configured to generate an environment model for positioning a mobile entity, the system comprising:
a mobile entity for devising a generated 3D model of a scanned environment of the mobile entity, the generated 3D model being configured as a point cloud,
a remote server comprising a processor operably coupled with a storage unit that is configured to store an existing 3D model of the environment of the mobile entity,
wherein the processor unit is configured to execute instructions which, when executed by the processor, cause the processor to perform steps of the method according to claim 1, wherein said steps include at least the matching of the generated 3D model with the existing 3D model and the generating of the database of the improved 3D.
